(19) United States
(12) Patent Application Publication
(10) Pub. No.: US 2014/0033070 A1
(43) Pub. Date: Jan. 30, 2014

(54) Graphical User Interface for Recipient Communication

(71) Applicant: Maryamossadat Nematollahi Mahani, Boulder, CO (US)

(72) Inventor: Maryamossadat Nematollahi Mahani, Boulder, CO (US)

(21) Appl. No.: 13/557,920

(22) Filed: Jul. 25, 2012

(51) Int. Cl. G06F 3/01; G06F 15/16

(52) U.S. Cl. 715/752

(57) ABSTRACT

A graphical user interface (GUI) is disclosed. The GUI includes a recipient area having one or more recipient fields to enter one or more recipient electronic mail (email) addresses and a first icon located next to a recipient email address designating a note component associated with a recipient email address.

### FIELD OF THE INVENTION

The invention relates to the field of graphical user interfaces, and in particular, to electronic mail system graphical user interfaces.

### BACKGROUND

Modern computer systems implement graphical user interfaces (GUIs) to enable users to execute commands by selecting from amongst various menu options. GUIs are implemented in electronic mail (email) systems to facilitate the generation of messages to be electronically transmitted by a sender to one or more recipients. However in conventional email systems, there is no easy way for adding sufficient information to individual recipients of an e-mail that has more than one recipient on the To, cc, or bcc list.

For instance, a sender attempting to send an email to a group of recipients may wish to note something to only one of the recipients without everyone else on the list becoming aware of that note. In conventional systems, the sender is required to compose a separate email to that individual recipient, or inform the recipient in some other way. This becomes a much more frequently occurring problem when the recipient is in the BCC field and the sender wants to provide a note, or additional information, to the recipient as to why the recipient is receiving a BCC.

Accordingly, an email system that provides the ability to include an additional component for each recipient of an email is desired.

### SUMMARY

In one embodiment, a graphical user interface (GUI) is disclosed. The GUI includes a recipient area having one or more recipient fields to enter one or more recipient electronic mail (email) addresses and a first icon located next to a recipient email address designating a note component associated with a recipient email address.

In another embodiment, a computer generated method disclosed. The method includes receiving an entry of an electronic mail (email) address within a recipient field of a graphical user interface (GUI); associating a notepad component with the email address and displaying a first icon next to the email address designating the notepad component.

In a further embodiment a computer system is disclosed including a memory to store an electronic mail (email) client application, a processor, coupled to the memory, to execute the email client application and a display device to display a graphical user interface (GUI) for the email client application upon the processor executing the email client application. The GUI includes a recipient area having one or more recipient fields to enter one or more recipient email addresses and a note component associated with each recipient email address entered in a recipient field.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIGS. 2A-2C illustrate embodiments of a GUI; and

FIG. 3 illustrates one embodiment of a computer system.

### DETAILED DESCRIPTION

A GUI for individualized recipient communication in an email system is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

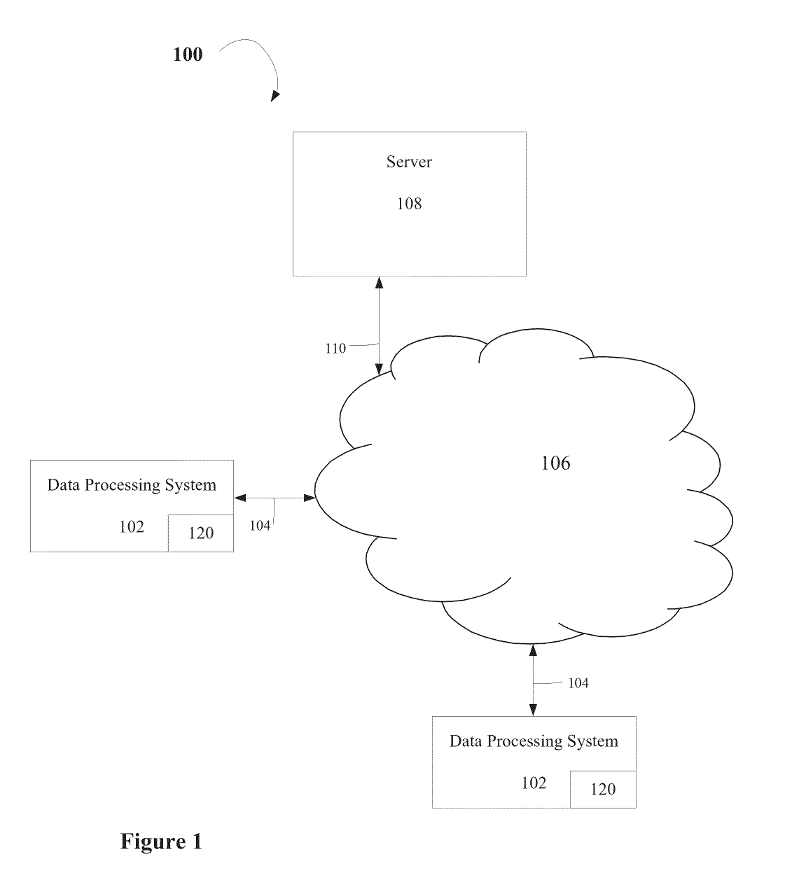

FIG. 1 illustrates one embodiment of a data processing system network 100. Network 100 includes data processing systems 102, which may be either desktops and/or mobile data processing systems, coupled via communications link 104 to network 106. In one embodiment, each data processing system 102 is a conventional data processing system including a processor, local memory, nonvolatile storage, and input/output devices such as a keyboard, mouse, trackball, and the like, all in accordance with the known art. In one embodiment, a data processing system 102 includes and employs the Windows operating system and/or network drivers permitting the data processing system 102 to communicate with network 106 for the purposes of employing resources within network 106.

Network 106 may be a local area network (LAN) or any other network over which requests may be submitted to a remote server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a server 108 that serves data over network 106 via communications link 110 between server 108 and network 106. Server 108 subsequently transmits and receives data via communications link 110 to one or more of data processing systems 102. In one embodiment, server 108 is an email server that distributes email between data processing systems 102 via network 106.

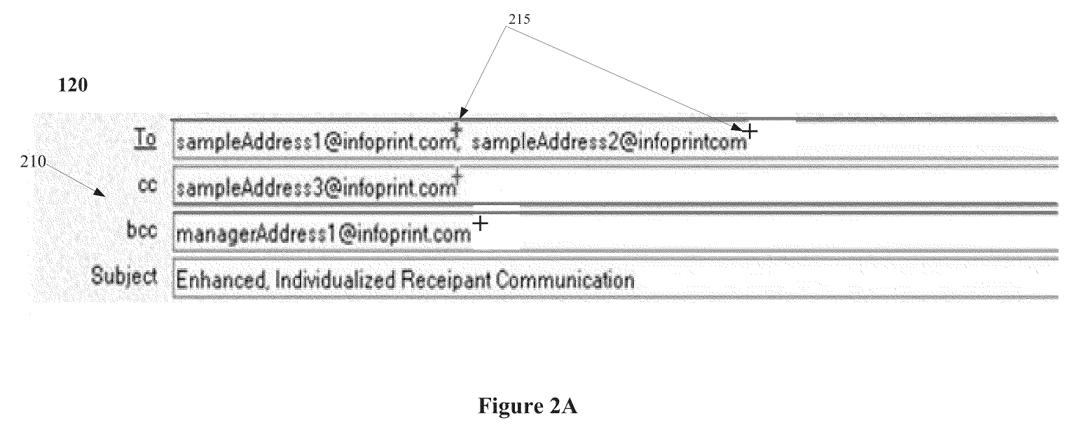

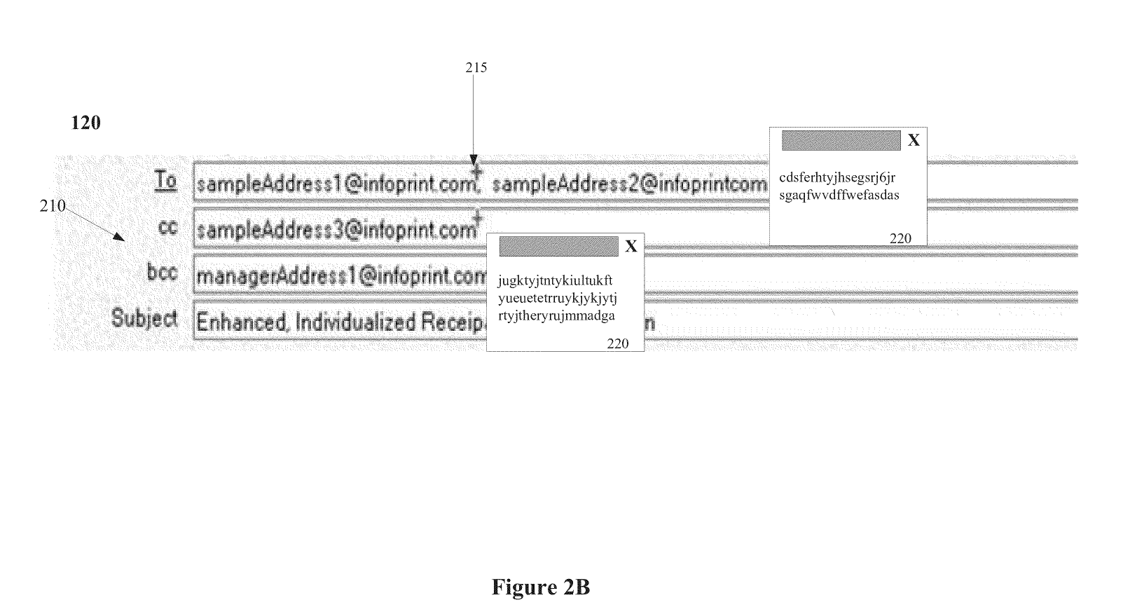

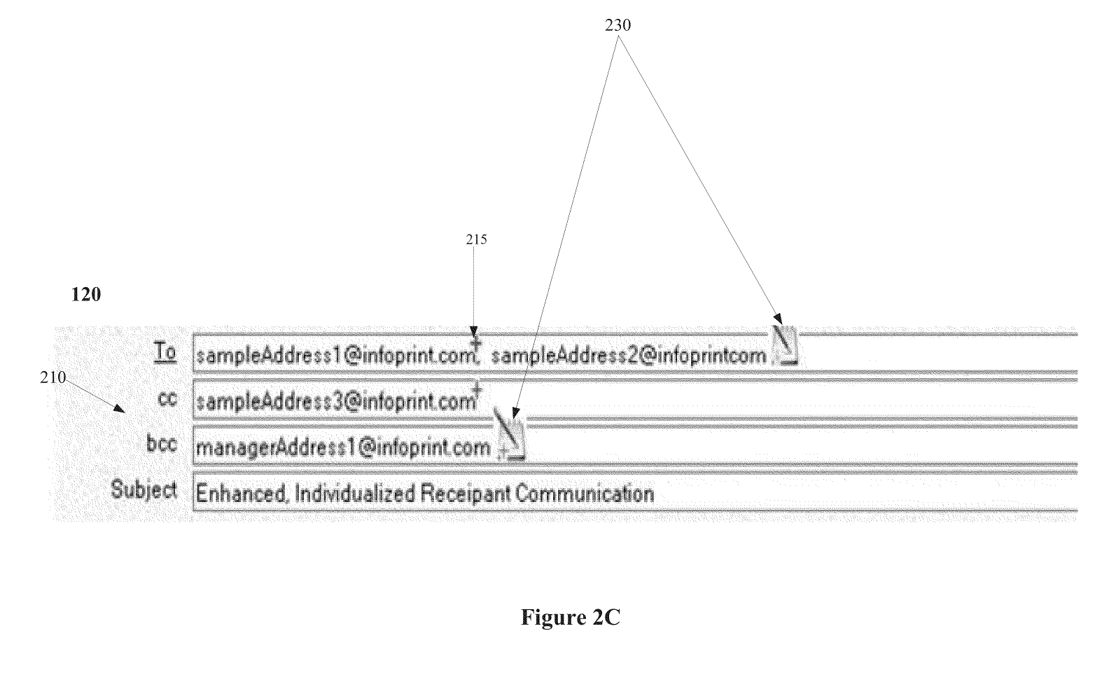

In such an embodiment, each data processing system 102 includes an email client application having a graphical user interface (GUI) 120 that enables a user at a system 102 to interact with client application. FIG. 2A illustrates one embodiment of GUI 120. As shown in FIG. 2A, GUI 120 presents a user with functions that enable setting up and sending an email message to one or more recipients.

Specifically, GUI 120 includes a recipient area having “To”, carbon copy (“cc”), blind carbon copy (“bcc”) recipient fields, and a “Subject” field. Generally, a recipient to whom the message is “To” may be expected to take some action in response to the action. Thus, to provide the “To” recipient, the user enters a corresponding email address for the address via a keyboard at data processing system 102. After the email address of the first recipient has been typed, subsequent “To” recipients may also be added. Subsequently, the user may wish to designate, for example, additional recipients of the message as “cc” or “bcc” by also typing the email addresses of those recipients.

According to one embodiment, a note component is provided for each recipient email address typed by the sender. In such an embodiment, the note component is designated by an icon 215 at the top right corner of the each recipient's address. Upon selecting an icon 215, a small editable notepad appears that may be used to provide a note to for particular recipient. FIG. 2B illustrates one embodiment of GUI 120 including notepads 220.

Once notepad 220 is closed by the user, the icon shape is changed to provide visual feedback to the user that a note has been composed for the recipient. FIG. 2C illustrates one embodiment of GUI 120 including after notepad 220 has been closed. As shown in FIG. 2C, icons 230 replace icons 215 for recipient addresses for which a note has been composed.

This above-described GUI provides an enhanced user experience of email applications and web-based clients by creating a faster, more effective, and more user friendly method for communication with different recipients of an e-mail.

While the illustrated embodiment shows specific icons and designations of “to”, “cc”, “bcc”, the present invention is not limited to such an embodiment. The present invention would be equally applicable to email application GUIs that have separate fields for these designations.

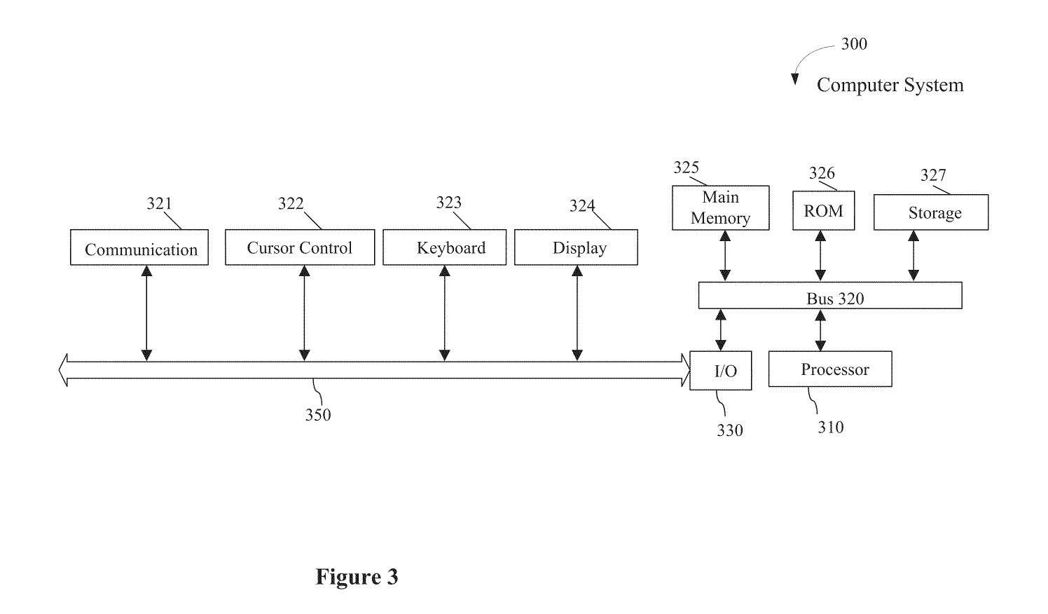

FIG. 3 illustrates a computer system 300 on which data processing system 102 and/or server 108 may be implemented. Computer system 300 includes a system bus 320 for communicating information, and a processor 310 coupled to bus 320 for processing information.

Computer system 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Computer system 300 also may include a read only memory (ROM) and or other static storage device 326 coupled to bus 320 for storing static information and instructions used by processor 310.

A data storage device 325 such as a magnetic disk or optical disc and its corresponding drive may also be coupled to computer system 300 for storing information and instructions. Computer system 300 can also be coupled to a second I/O bus 350 via an I/O interface 330. A plurality of I/O devices may be coupled to I/O bus 350, including a display device 324, an input device (e.g., an alphanumeric input device 323 and or a cursor control device 322). The communication device 321 is for accessing other computers (servers or clients). The communication device 321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a memory to store an electronic mail (email) client application;
a processor, coupled to the memory, to execute the email client application; and
a display device to display a graphical user interface (GUI) for the email client application upon the processor executing the printing product, the GUI having:
a recipient area having one or more recipient fields to enter one or more recipient email addresses; and
a note component associated with each recipient email address entered in a recipient field.

2. The computer system of claim 1 wherein the note component is designated by a first icon located next to a recipient email address.

3. The computer system of claim 2 wherein the note component comprises a notepad upon the first icon being selected by a user.

4. The computer system of claim 3 wherein the notepad is editable to enable a user to provide a note for the corresponding recipient.

5. The computer system of claim 4 wherein the note component is designated by a second icon located next to a recipient email address upon closing of the edited notepad.

6. The computer system of claim 1 wherein the one or more recipient fields comprises To, carbon copy (cc), blind carbon copy (bcc) recipient fields.

7. A computer generated method comprising:
receiving an entry of an electronic mail (email) address within a recipient field of a graphical user interface (GUI);
associating a notepad component with the email address; and
displaying a first icon next to the email address designating the notepad component.

8. The method of claim 7 further comprising:
detecting a selection of the first icon; and
opening a notepad.

9. The method of claim 8 wherein the notepad is editable to enable generation of a note.

10. The method of claim 9 further comprising:
detecting that the notepad has been edited; and
detecting that the notepad has been closed.

11. The method of claim 10 further comprising displaying a first icon next to the email address upon detecting that the notepad has been edited and closed.

12. A graphical user interface (GUI) comprising:
a recipient area having one or more recipient fields to enter one or more recipient electronic mail (email) addresses; and
a first icon located next to a recipient email address designating a note component associated with a recipient email address.

13. The GUI of claim 12 further comprising a notepad displayed upon selection of the first icon.

14. The GUI of claim 13 wherein the notepad is editable to enable a user to provide a note for the corresponding recipient.

15. The GUI of claim 14 further comprising a second icon designating the note component upon the notepad being edited and closed.

16. An article of manufacture comprising a machine-readable medium including data that, when accessed by a machine, cause the machine to perform operations comprising:
receiving an entry of an electronic mail (email) address within a recipient field of a graphical user interface (GUI);
associating a notepad component with the email address; and
displaying a first icon next to the email address designating the notepad component.

17. The article of manufacture of claim 16 comprising a machine-readable medium including data that, when accessed by a machine, further cause the machine to perform operations comprising:
detecting a selection of the first icon; and
opening a notepad.

18. The article of manufacture of claim 17 wherein the notepad is editable to enable generation of a note.

19. The article of manufacture of claim 18 comprising a machine-readable medium including data that, when accessed by a machine, further cause the machine to perform operations comprising:
detecting that the notepad has been edited; and
detecting that the notepad has been closed.

20. The article of manufacture of claim 19 comprising a machine-readable medium including data that, when accessed by a machine, further cause the machine to perform operations comprising displaying a first icon next to the email address upon detecting that the notepad has been edited and closed.
